(19) United States
(12) Patent Application Publication
(10) Pub. No.: US 2016/0062774 A1
(43) Pub. Date: Mar. 3, 2016

(54) METHOD, USER DEVICE AND STORAGE MEDIUM FOR CONTROLLING BOOT SCREEN TO BE PLAYED

(71) Applicant: Hisense Co., Ltd., Qingdao (CN)

(72) Inventor: Yanmei YUAN, Qingdao (CN)

(21) Appl. No.: 14/707,214

(22) Filed: May 8, 2015

(30) Foreign Application Priority Data
Aug. 27, 2014 (CN) 201410428114.6

(51) Int. Cl. G06F 9/44

(52) U.S. Cl. CPC G06F 9/4408; G06F 9/4413

(57) ABSTRACT

Some embodiments of the disclosure provide a method, user device and storage medium for controlling a boot screen to be played, where the method for controlling the boot screen to be started includes: playing, by a user device, a boot screen upon being powered on; detecting, by the user device, in real time whether a booting preparation of a booting signal source is completed; and stopping, by the user device, the boot screen from being played upon detecting that the booting preparation of the booting signal source is completed.

### CROSS-REFERENCE TO RELATED APPLICATION

This application claims the benefit and priority of Chinese Patent Application No. 201410428114.6 filed Aug. 27, 2014. The entire disclosure of the above application is incorporated herein by reference.

### FIELD

The present disclosure relates to the field of electronics and particularly to a method, user device and storage medium for controlling a boot screen to be played.

### BACKGROUND

This section provides background information related to the present disclosure which is not necessarily prior art.

At present there are more and more users using intelligent devices, e.g., intelligent TV sets, set-top boxes, multimedia boxes, etc., and a booting speed of these intelligent devices in use is an important factor influencing experiences of the users.

Some preparation period of time is currently required for the intelligent devices to boot up, and the intelligent devices may appear with a black screen, a blue screen or an unstable signal or even without any signal, etc., during this period of time. In order to avoid these instances from being seen by the users, a boot screen (which may be an animation or still image) may be played in the system, and there will be no operations by the users until playing of the boot screen is completed.

### SUMMARY

This section provides a general summary of the disclosure, and is not a comprehensive disclosure of its full scope or all of its features.

In an aspect, some embodiments of the disclosure provide a method for controlling a boot screen to be played, the method including:

playing, by a user device, a boot screen upon being powered on;

detecting, by the user device, in real time whether a booting preparation of a booting signal source is completed; and

stopping, by the user device, the boot screen from being played upon detecting that the booting preparation of the booting signal source is completed.

In another aspect, some embodiments of the disclosure further provide a user device including:

one or more processors; and

one or more computer readable memories;

wherein the one or more computer readable memories have instruction codes stored therein and the one or more processors execute the instruction codes so that the user device performs at least the following operations:

controlling the user device to play a boot screen upon being powered on;

detecting in real time whether a booting preparation of a booting signal source is completed; and

controlling the user device to stop the boot screen from being played upon detecting that the booting preparation of the booting signal source is completed.

In still another aspect, some embodiments of the disclosure further provide a computer readable storage medium, including instruction codes stored thereon, the instruction codes are executed to enable a user device to perform at least the following operations:

controlling the user device to play a boot screen upon being powered on;

detecting in real time whether a booting preparation of a booting signal source is completed; and

controlling the user device to stop the boot screen from being played upon detecting that the booting preparation of the booting signal source is completed.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a flow chart of a method for controlling a boot screen to be played according to some embodiments of the disclosure;

FIG. 2 illustrates a flow chart where a preparation completion flag is set for an application for which a signal needs to be decrypted according to some embodiments of the disclosure;

FIG. 3 illustrates a flow chart where a preparation completion flag is set for an application for which a main interface needs to be drawn according to some embodiments of the disclosure;

FIG. 4 illustrates a flow chart of setting a current signal flag according to some embodiments of the disclosure;

FIG. 5 illustrates a flow chart of controlling dynamically a period of time, for which a boot screen is played, for a different booting signal source according to some embodiments of the disclosure;

FIG. 6 illustrates a general flow chart of a method for controlling a boot screen to be played, where a signal is decrypted, according to some embodiments of the disclosure;

FIG. 7 illustrates a schematic structural diagram of a user device according to some embodiments of the disclosure; and

FIG. 8 illustrates a schematic structural diagram of another user device according to some embodiments of the disclosure.

Corresponding reference numerals indicate corresponding parts throughout the several views of the drawings.

### DETAILED DESCRIPTION

Example embodiments will now be described more fully with reference to the accompanying drawings.

In some embodiments of the disclosure, a user device plays a boot screen upon being powered on, and the user device detects in real time whether a booting preparation of a booting signal source is completed and stops the boot screen from being played upon detecting that the booting preparation of the booting signal source is completed. Due to an additional operation of detecting in real time whether a booting preparation of a booting signal source is completed in the embodiments of the disclosure, the boot screen may be stopped from being played upon detecting that the booting preparation is completed, thus a period of time, for which the boot screen is played, need not be determined as the longest one of booting periods of time required in respective booting signal sources, thereby improving a booting speed of the intelligent device and shortening a period of time for which a user waits for the intelligent device to boot up.

Some embodiments of the disclosure will be described below with reference to the drawings, and it shall be noted that these embodiments described here are merely intended to illustrate and describe but not to limit the disclosure. Moreover the embodiments in the disclosure and features in the embodiments may be combined with each other unless there is any confliction.

A method and a user device according to the disclosure will be described below in some embodiments thereof with reference to the drawings.

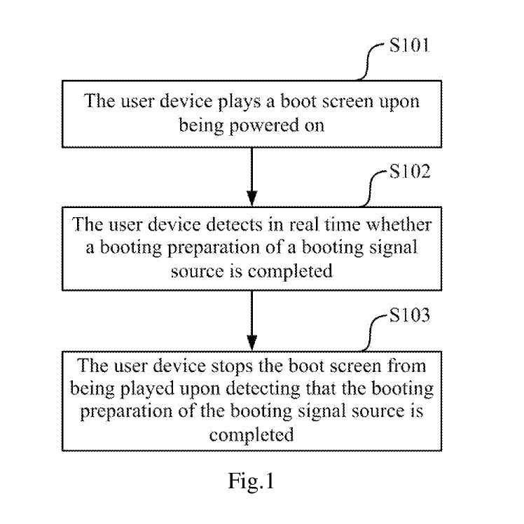

As illustrated in FIG. 1, a method for controlling a boot screen to be played according to an embodiment of the disclosure may include the following operations:

S101. The user device plays a boot screen upon being powered on;

S102. The user device detects in real time whether a booting preparation of a booting signal source is completed; and

S103. The user device stops the boot screen from being played upon detecting that the booting preparation of the booting signal source is completed.

In some embodiments, the booting signal source refers to a first signal source presented to a user after the user device is powered on, i.e., a signal source when the user device is powered on.

The user device according to the embodiment of the disclosure may stop in a timely manner the boot screen from being played upon detecting that the booting preparation of the booting signal source is completed. Since there are different periods of time required for completing the booting preparation of different booting signal sources, the user device may control dynamically the period of time, for which the boot screen is played, for a different booting signal source, thereby improving a booting speed of the intelligent device and shortening a period of time for which a user waits for the intelligent device to boot up, as compared with the prior art where the period of time, for which the boot screen is played, is determined as the longest one of the booting periods of time required in the respective booting signal sources.

The user device according to the embodiments of the disclosure may be an intelligent TV set, a multimedia box, a set-top box or any of other various intelligent devices.

Particularly the user device may detect in real time whether the booting preparation of the booting signal source is completed in numerous ways, for example, the user device may detect whether the booting preparation is completed by detecting whether a running of an application corresponding to the booting signal source is completed.

Alternatively, the judgment of whether the booting preparation is completed may be determined from a preparation completion flag according to some embodiments of the disclosure as described below briefly.

I. For example, the preparation completion flag may be set as follows:

Booting preparation may be made by starting the application corresponding to the booting signal source after the user device is powered on;

The preparation completion flag of the application corresponding to the booting signal source may be set upon the booting preparation is completed.

The application corresponding to the booting signal source will be started after the user device is powered on, where the application is started while the user device makes booting preparation (i.e. the booting preparation of the booting signal source), and the preparation completion flag of the application corresponding to the booting signal source will be set after booting preparation of the user device is completed.

The user device may set the preparation completion flag of the application corresponding to the booting signal source so that the user device may read in real time the preparation completion flag and stop the boot screen from being played upon determining that the booting preparation of the booting signal source is completed, thereby shortening a period of time for which a user waits for the intelligent device to boot up.

II. The operation of detecting in real time whether the booting preparation is completed may be implemented as follows:

The user device detects in real time whether a preparation completion flag of the application corresponding to the booting signal source is read; and

The user device determines that the booting preparation of the booting signal source is completed upon the preparation completion flag is read.

Particularly the preparation completion flag may be set at the backend of the user device; and the operation of detecting in real time whether the booting preparation is completed may be implemented at the front end of the user device.

For example, the preparation completion flag may be represented as the value of a bit, for example, the value 1 of the bit may indicate a preparation completion flag.

If the booting signal source is a TV set signal source, then the backend of the user device starts the application of the booting signal source and sets the value of the bit for the application of the booting signal source from 0 to 1 when running of the application of the booting signal source is completed; and

Correspondingly the front end of the user device detects in real time the value of the bit for the application of the booting signal source and determines that the booting preparation of the booting signal source is completed when the value is changed from 0 to 1.

In some embodiments, the user device may determine that the booting preparation is completed in numerous ways, for example, in addition to the implementation that the booting preparation is determined to be completed upon initialization of the application corresponding to the booting signal source is completed, i.e., starting of the application corresponding to the booting signal source is completed, a booting preparation timer may be set, and the booting preparation may be determined to be completed when the booting preparation timer expires. Several instances thereof will be described below respectively.

In a first instance, a booting preparation timer is set.

In order to ensure the boot screen to be stopped normally even if there is an accidental condition occurring with the user device, for example, the user device fails to read the preparation completion flag of the application corresponding to the booting signal source, a booting preparation timer may be added to the user device as a protection measure. When the user device is powered on by the user, the booting preparation timer is started and expires upon reaching a preset counting period of time, which indicates that the booting preparation is completed. Alternatively, the counting period of time of the booting preparation timer may be set to the longest one of booting periods of time required in respective booting signal sources.

In a second instance, the user device may set the preparation completion flag of the application corresponding to the booting signal source upon initialization of the application corresponding to the booting signal source is completed, and if the user device may read normally the preparation completion flag, then it indicates that the booting preparation is completed.

The booting signal source needs to be identified due to a large number of signal sources of the user device, e.g., Asia Television Limited (ATV), Digital Video Broadcasting-Cable (DVBC), Video Graphic Array (VGA), video on demand, an application center and other signal sources.

In some embodiments, before the user device detects in real time whether the preparation completion flag of the application corresponding to the booting signal source is read, the method further includes:

The user device determines a signal source corresponding to a current signal identifier according to a preset correspondence relationship between a signal identifier and a signal source and takes the determined signal source as the booting signal source.

Since the user device may determine the signal source corresponding to the current signal identifier and take the determined signal source as the booting signal source, the user device may judge for each different booting signal source whether booting preparation of the booting signal source is completed, so that the method for controlling a boot screen to be played according to the embodiment of the disclosure may be applicable to various intelligent devices with different signal sources.

In some embodiments, the signal identifier may be set to a set of specific values, e.g., binary numerals, octal numerals, etc., each of which may represent a corresponding signal source. The particular type of values to represent the signal identifier may be selected as needed in real manufacturing.

For example, there are five signal sources including ATV, DVBC, VGA, video on demand and an application center in an intelligent TV set, and each signal source may be set in the system to correspond to a signal identifier which may be represented as a set of binary numerals, for example, 0000 indicates the signal identifier corresponding to the AVT signal source, 0001 indicates the signal identifier corresponding to the DVBC signal source, 0010 indicates the signal identifier corresponding to the VGA signal source, 0100 indicates the signal identifier corresponding to the DVBC signal source, 1000 indicates the signal identifier corresponding to the video on demand signal source, and 0011 indicates the signal identifier corresponding to the application center signal source.

The current signal identifier needs to be set before the user device is powered off last time, so that the user device may determine the booting signal source upon being powered on next time.

At least the following three schemes will be applicable:

In a first scheme, the user device determines a signal identifier corresponding to a default signal source as the current signal identifier;

In a second scheme, the user device determines a signal identifier corresponding to a specific signal source preset by the user as the current signal identifier;

In a third scheme, the user device determines a signal identifier corresponding to a signal source used lastly before the user device is powered off last time as the current signal identifier.

The three schemes above may be applied alone or in combination.

For example, both the first scheme and the second scheme are applied, where firstly it is judged whether a specific signal source has been preset by the user, and if so, then the signal identifier corresponding to the specific signal source preset by the user may be determined as the current signal identifier; otherwise, a signal identifier corresponding to a default signal source may be determined as the current signal identifier.

For example, both the first scheme and the third scheme are applied, where firstly it is judged whether the user has configured to use a signal source used last time, and if so, then a signal identifier corresponding to a signal source used lastly before the user device is powered off last time may be determined as the current signal identifier; otherwise, a signal identifier corresponding to a default signal source may be determined as the current signal identifier.

For example, all of the first scheme, the second scheme and the third scheme are applied, where if a signal source used lastly before the intelligent TV set is powered off last time is the VGA signal source and the user has configured to use a signal source used last time, then the signal identifier corresponding to the VGA signal source may be determined as the current signal identifier; otherwise, if the user has not configured to use a signal source used last time and the DVBC is preset as a specific signal source by the user, then the signal identifier corresponding to the DVBC signal source may be determined as the current signal identifier; otherwise, if there is no specific signal source preset by the user, then the signal identifier corresponding to the default ATV signal source may be determined as the current signal identifier.

Alternatively, the user device sets the current signal identifier as follows:

The user device sets the current signal identifier when a signal source is switched before the user device is powered off last time.

In an implementation, the user device may set the current signal identifier each time the signal source is switched.

With the third scheme above (where a signal identifier corresponding to a signal source used lastly before the user device is powered off last time is determined as the current signal identifier), each time the signal source is switched, the switched signal source may be the signal source used lastly before the user device is powered off last time. Accordingly, an alternative way is to set the current signal identifier to the signal identifier corresponding to the switched signal source each time the signal source is switched in case of applying the third scheme; otherwise, the current signal identifier may not be set each time the signal source is switched.

For example, with the third scheme above applied, while the intelligent TV set is being used by the user, before the intelligent TV set is powered off last time, the user initially uses the ATV signal source, so the signal identifier corresponding to the ATV signal source may be determined as the current signal identifier, and if the user switches to the DVBC signal source, then the system may replace the current signal identifier of the intelligent TV set with the signal identifier corresponding to the DVBC signal source.

In some embodiments, the user device may set a first boot screen play timer in addition to the three schemes above in which the current signal identifier is set.

Alternatively, the user device may further determine the booting signal source as follows:

If the user device fails to determine the current signal identifier, then the user device starts the first boot screen play timer; and

The user device stops the boot screen from being played after the first boot screen play timer expires.

When the user devices determines the booting signal source, a first boot screen play timer may be added to the user device as a protection measure in order to avoid the user device from failing to read the current signal identifier due to an accidental condition so that the boot screen will not be stopped from being played.

For example, when the booting application fails to be started normally or a file in which the current signal identifier is stored fails so that the user device fails to read the current signal identifier, the user device may start the first boot screen play timer, and if a counting period of time of the first boot screen play timer is preset to 80 seconds, then the user device will stop the boot screen from being played when the preset counting period of time which is 80 seconds expires.

Alternatively, in some embodiments, in order to prevent the application corresponding to the booting signal source from failing to be started normally so that the boot screen will not be stopped from being played, another protection measure may be taken, that is, a second boot screen play timer may be set in the user device, and the boot screen will be stopped from being played after the second boot screen play timer expires.

For example, the second boot screen play timer may be started at the same time when the user device detects in real time whether booting preparation of the booting signal source is completed.

The user device stops the second boot screen play timer upon detecting that booting preparation of the booting signal source is completed before the second boot screen play timer expires; and

The user device stops the boot screen from being played after the second boot screen play timer expires.

In some embodiments, after the user device is powered on by the user, it may proceed directly to both the operation of detecting in real time whether booting preparation of the booting signal source is completed and the operation of starting the second boot screen play timer without firstly judging whether the user device has read the current signal identifier, where a counting period of time may be preset for the second boot screen play timer, and if completion of booting preparation of the booting signal source is detected before the second boot screen play timer expires, then the second boot screen play timer is stopped and the flow proceeds to other operations (for example, where the boot screen is stopped from being played); and if the application corresponding to the booting signal source fails to be started normally, then the user device may stop the boot screen from being played when the counting period of time of the second boot screen play timer expires. Thus the user device may stop the boot screen when the second boot screen play timer expires even if the application corresponding to the booting signal source fails to be started normally, thus preventing the boot screen from failing to be stopped.

For example, the user device may derive an empirical value from common lengths of booting periods of time or as a result of testing the lengths of booting periods of time for different booting signal sources in a real hardware booting environment, and in order to enable the respective signal resources of the user device to be presented to the user at their optimum effects, the longest one of the booting periods of time required in the respective booting signal sources may be determined as the empirical value, and if the empirical value is 80 seconds, then the user device may set the counting period of time of the second boot screen play timer to 80 seconds and stop the boot screen from being played 80 seconds after the user device is powered on when the application corresponding to the booting signal source fails to be started normally.

Alternatively, in some embodiments, after the user device is powered on, there are two scenarios below of the application corresponding to the booting signal source being started:

In a first scenario, the application corresponding to the booting signal source may be a signal display application, e.g., Live TV of Vidaa TV, where a signal is displayed directly, but there is no main interface, and a decryption completion flag needs to be set. Before decryption is completed, the system may display “No Signal” or “Channel Encrypted”; and after the signal is decrypted successfully, a recall function may make the floating window of “No Signal” or “Channel Encrypted” disappear and set the decryption completion flag.

In a second scenario, the application corresponding to the booting signal source may be an application with a main interface, e.g., video on demand of Vidaa TV, where a drawing completion flag corresponding to the application is set after the main interface is parsed and drawing of the interface is completed.

Alternatively, the two scenarios above may occur separately or in combination dependent upon what experience will be presented by the user device of the real application to the user. If only the first scenario above occurs, then the preparation completion flag above is a decryption completion flag; if only the second scenario above occurs, then the preparation completion flag above is a drawing completion flag; and if both of the two scenarios above occur, then the preparation completion flag above may be a decryption completion flag or a drawing completion flag.

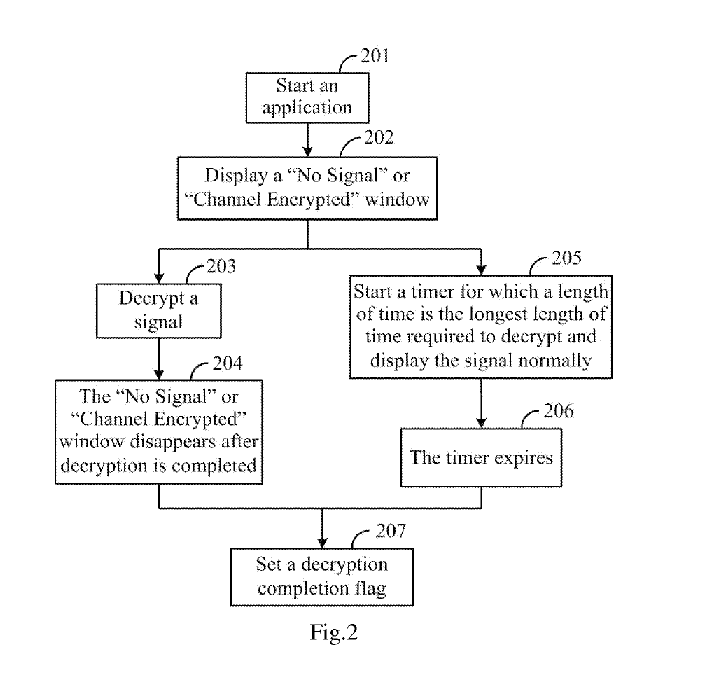

As illustrated in FIG. 2, there is illustrated a flow chart where a preparation completion flag is set for an application for which a signal needs to be decrypted according to some embodiments of the disclosure, the flow including:

In the operation 201, the application corresponding to the booting signal source is started after the user device is powered on;

In the operation 202, the user device displays a “No Signal” or “Channel Encrypted” window after the application is started, and then proceeds to the operation 203 or the operation 205 dependent upon whether the user device is operating normally;

In the operation 203, the signal is decrypted in the event that the user device is operating normally;

In the operation 204, the user device makes the “No Signal” or “Channel Encrypted” window disappear after decryption of the signal is completed, and then proceeds to the operation 207;

In the operation 205, a timer is added to the user device as a protect measure in order to prevent some accidental condition from occurring. For example, when the user has no incoming signal or has not inserted a decryption card so that the signal is maintained as “No Signal” or “Channel Encrypted” all the time, the user device may start the timer, where a length of time of the timer is the longest length of time required to decrypt the signal normally;

In the operation 206, the timer expires, and then the flow proceeds to the operation 207; and

In the operation 207, a decryption completion flag is set when the decryption is completed or the timer expires.

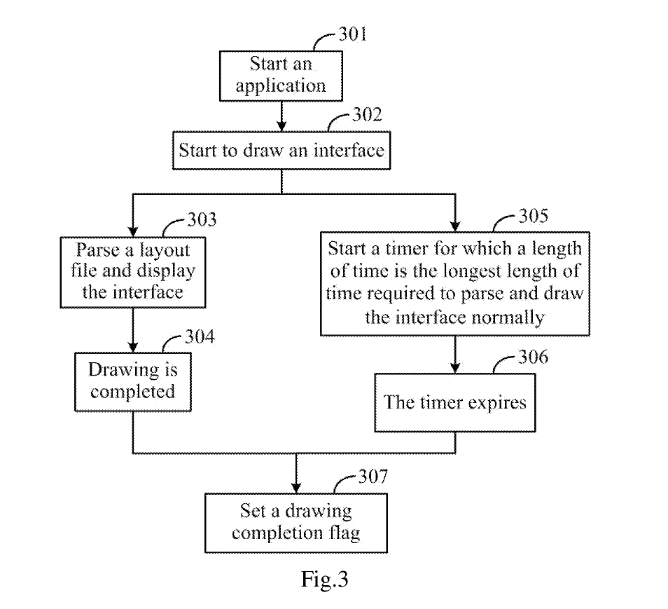

As illustrated in FIG. 3, there is illustrated a flow chart where a preparation completion flag is set for an application for which a main interface needs to be drawn according to some embodiments of the disclosure, the flow including:

In the operation 301, the application of the booting signal source is started after the user device is powered on;

In the operation 302, after the application is started, the user device starts to draw the interface to be displayed and then proceeds to the operation 303 or the operation 305 dependent upon whether the user device is operating normally;

In the operation 303, the user device parses a layout file and displays the interface in the event that the user device is operating normally;

In the operation 304, the user device proceeds to the operation 307 after completing drawing of the interface.

In the operation 305, a timer is added to the user device as a protection measure in order to prevent some accidental condition from occurring. For example, when the main interface configured by a backend server is being loaded all the time but fails to be displayed completely due to some network reason, the user device may start the timer, where a length of time of the timer is the longest length of time required to parse and draw the interface normally, and then proceed to the operation 306.

In the operation 306, the timer expires, and then the flow proceeds to the operation 307; and

In the operation 307, a drawing completion flag is set when drawing of the interface is completed or the timer expires.

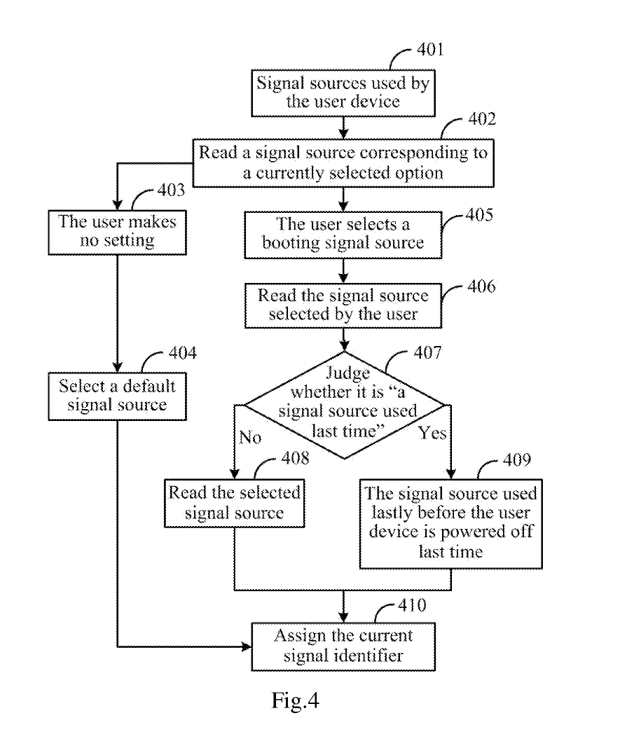

Alternatively, as illustrated in FIG. 4, there is illustrated a flow chart of setting the current signal identifier according to some embodiments of the disclosure, the flow including:

In the operation 401, there are signal sources used by the user device in operation;

In the operation 402, then a signal source corresponding to a currently selected option is read;

In the operation 403, if the user selects no booting signal source, then the flow proceeds to the operation 404;

In the operation 404, the user device determines a signal identifier corresponding to a default signal source as the current signal identifier and proceeds to the operation 410;

In the operation 405, if the user selects a booting signal source, then the flow proceeds to the operation 406;

In the operation 406, the user device reads the signal source selected by the user and proceeds to the operation 407;

In the operation 407, it is judged whether the signal source is “a signal source used last time”, and if so, then the flow proceeds to the operation 409; otherwise, the flow proceeds to the operation 408, where the signal source used last time refers to a signal source used lastly before the user device is powered off last time;

In the operation 408, the selected signal source is read as the booting signal source, and the flow proceeds to the operation 410;

In the operation 409, the signal source used lastly before the user device is powered off last time is used as the booting signal source, and the flow proceeds to the operation 410; and

In the operation 410, the current signal identifier corresponding to the booting signal source selected by the user is assigned.

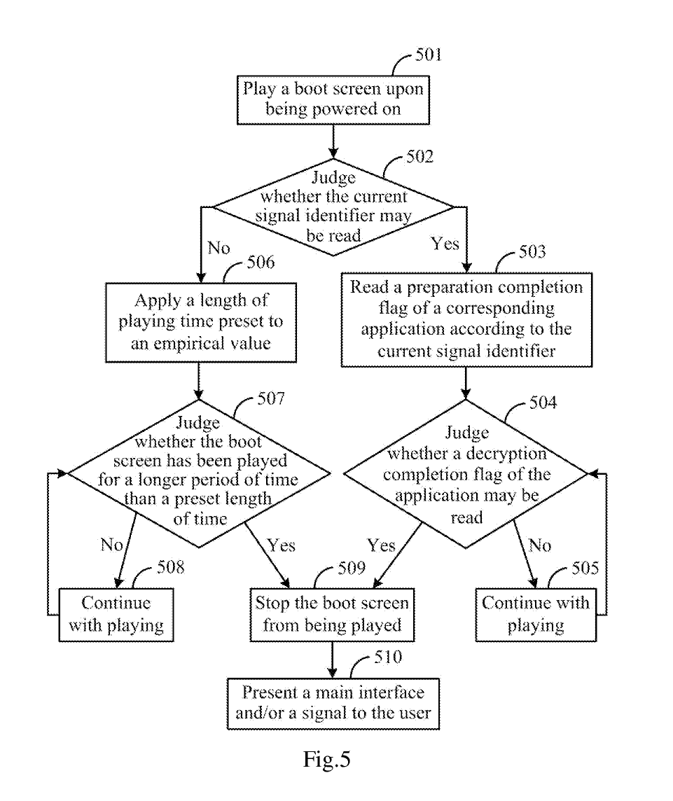

Alternatively, as illustrated in FIG. 5, there is illustrated a flow chart of controlling dynamically a period of time, for which a boot screen is played, for a different booting signal source according to some embodiments of the disclosure, the flow including:

In the operation 501, a boot screen is played when the user device is powered on;

In the operation 502, it is judged after the booting whether the current signal identifier can be read, and if so, then the flow proceeds to the operation 503; otherwise, the flow proceeds to the operation 506;

In the operation 503, a preparation completion flag of a corresponding application is read according to the current signal identifier;

In the operation 504, it is judged whether a decryption completion flag (i.e., a preparation completion flag) of the application can be read, and if so, then the flow proceeds to the operation 509; otherwise, the flow proceeds to the operation 505;

In the operation 505, the user device continues with playing the boot screen, and the flow proceeds to the operation 504;

In the operation 506, the user device applies a length of playing time which is preset to an empirical value and proceeds to the operation 507;

In the operation 507, it is judged whether the boot screen has been played for a longer period of time than a preset length of time, and if so, then the flow proceeds to the operation 509; otherwise, the flow proceeds to the operation 508;

In the operation 508, the user device continues with playing the boot screen and proceeds to the operation 507;

In the operation 509, the user device stops the boot screen from being played and further proceeds to the operation 510; and

In the operation 510, a main interface and/or a signal is presented to the user after the booting is completed.

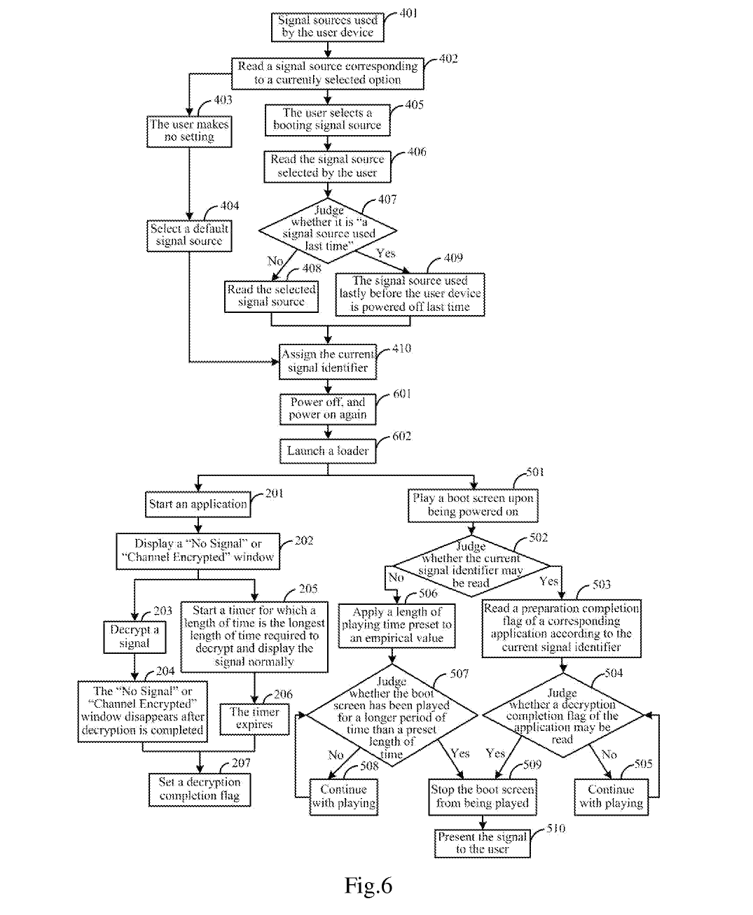

As illustrated in FIG. 6, there is illustrated a flow chart of a method for controlling a boot screen to be played, where a signal is decrypted, according to some embodiments of the disclosure. In some embodiments of the disclosure, before the user device is powered off last time, the user device firstly sets the current signal identifier as illustrated in FIG. 4; and then proceeds to the operation 601 where the user device is powered on again after being powered off; and after the user device is powered on again, the user device proceeds to the operation 602 where a loader is launched; and next a preparation completion flag is set for an application, selected at the backend of the user device, for which a signal needs to be decrypted, as illustrated in FIG. 2, and in the meanwhile, the front end of the user device also controls dynamically a length of time, for which the boot screen is played, for a different booting signal source, as illustrated in FIG. 5.

Some embodiments of the disclosure further provide a user device for controlling a boot screen to be played, and since the user device addresses the problem under a similar principle to the method above for controlling a boot screen to be played, reference may be made to the implementation of the method above for an implementation of the user device, so a repeated description thereof will be omitted here.

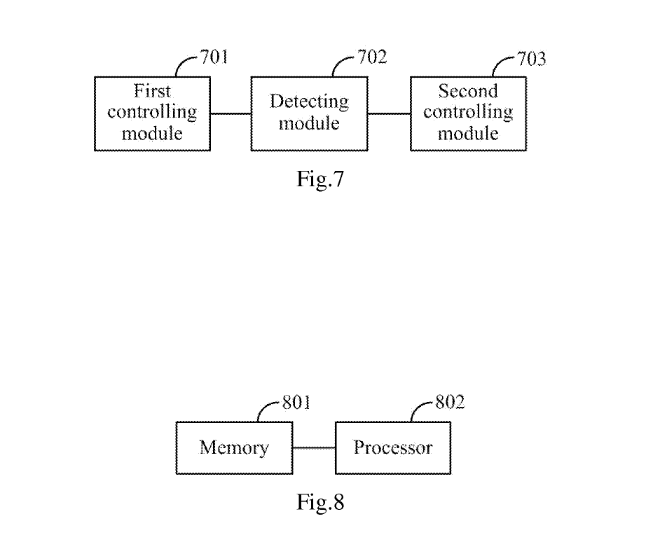

As illustrated in FIG. 7, there is illustrated a schematic structural diagram of a user device according to some embodiments of the disclosure, the user device including:

A first controlling module 701 is configured to control the user device to play a boot screen upon being looted;

A detecting module 702 is configured to detect in real time whether a booting preparation of a booting signal source is completed; and

A second controlling module 703 is configured to control the user device to stop the boot screen from being played when completed booting preparation of the booting signal source is detected.

Alternatively, the detecting module 702 may be configured:

To detect in real time whether a preparation completion flag of an application corresponding to the booting signal source is read; and to determine that the booting preparation of the booting signal source is completed upon the preparation completion flag is read.

Alternatively, the detecting module 702 may be further configured:

When the user device is powered on, to start the application corresponding to the booting signal source for a booting preparation; and when the booting preparation is completed, to set the preparation completion flag of the application corresponding to the booting signal source.

Alternatively, the detecting module 702 may be further configured to determine that the booting preparation of the booting signal source is completed when one of the following situations occurs:

A booting preparation timer expires;

Initialization of the application corresponding to the booting signal source is completed.

Alternatively, the detecting module 702 may be further configured:

Before detecting in real time whether the preparation completion flag of the application corresponding to the booting signal source is read, to determine a signal source corresponding to a current signal identifier according to a preset correspondence relationship between a signal identifier and a signal source and to take the determined signal source as the booting signal source.

Alternatively, the detecting module 702 may be further configured:

If the current signal identifier fails to be determined, then to start a first boot screen play timer; and the second control module 703 controls the user device to stop the boot screen from being played after the first boot screen play timer expires.

Alternatively, the detecting module 702 may be further configured to set the current signal identifier in one of the following schemes before the user device is powered off last time:

A signal identifier corresponding to a default signal source is determined as the current signal identifier;

A signal identifier corresponding to a specific signal source preset by a user is determined as the current signal identifier; and

A signal identifier corresponding to a signal source used lastly before the user device is powered off last time is determined as the current signal identifier.

Alternatively, the detecting module 702 may be further configured:

To set the current signal identifier when a signal source is switched before the user device is powered off last time.

Alternatively, the detecting module 702 may be further configured:

To start a second boot screen play timer at the same time when detecting in real time whether booting preparation of the booting signal source is completed; to stop the second boot screen play timer upon detecting that booting preparation of the booting signal source is completed before the second boot screen play timer expires; and to stop the boot screen from being played after the second boot screen play timer expires.

In the embodiment of the disclosure, there is an additional operation of detecting in real time whether a booting preparation of a booting signal source is completed, and the boot screen is stopped from being played when the user device detects that the booting preparation is completed, so that the intelligent device may control dynamically the period of time, for which the boot screen is played, for a different booting signal source to thereby improve a booting speed of the intelligent device and shorten a period of time for which the user waits for the intelligent device to boot up, as compared with the prior art where the period of time, for which the boot screen is played, is determined as the longest one of the booting periods of time required in the respective booting signal sources.

Referring to FIG. 8, there is illustrated another user device according to some embodiments of the disclosure, the user device including a memory 801 and a processor 802, where:

One or more program codes are stored in the memory 801 and configured to be performed by one or more of the processors 802 above. The one or more program codes above contain instructions for performing the methods as illustrated in FIG. 1 to FIG. 6, and reference may be made to FIG. 1 to FIG. 6 and the descriptions thereof for details of the methods.

In another aspect, some embodiments of the disclosure further provide a computer readable storage medium which may be a computer readable storage medium contained in the memories in the embodiments above; or may be a separate computer readable storage medium which is not installed into the user device. The computer readable storage medium stores one or more programs (in some embodiments, the computer readable storage medium may be one or more magnetic-disk storage devices, flash memory devices or other nonvolatile solid storage devices, CD-ROMs, optical memories, etc.), and the one or more programs may be executed by one or more processors to perform the method for controlling a boot screen to be played. Reference may be made to the descriptions of the embodiments illustrated in FIG. 1 to FIG. 6 for the operations in the method, so a repeated description thereof will be omitted here.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram may be embodied in computer program instructions. These computer program instructions may be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions may also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions may also be loaded onto the computer or the other programmable data processing device so that a series of operational operations are performed on the computer or the other programmable data processing device to create a computer implemented process so that the instructions executed on the computer or the other programmable device provide operations for performing the functions specified in the flow(s) of the flow chart and/or the block(s) of the block diagram.

Those skilled in the art may clearly appreciate from the foregoing description of the embodiments that the embodiments of the disclosure may be implemented in hardware or in software plus a necessary general hardware platform. Based upon such understanding, the technical solutions of the embodiments of the disclosure may be embodied in the form of a program product which may be stored in a nonvolatile storage medium (e.g., a CD-ROM, a U disk, a mobile hard disk, etc.) and which includes several instructions to cause a computer device (e.g., a personal computer, a server, a network device, etc.) to perform the method according to the respective embodiments of the disclosure.

Those skilled in the art may appreciate that the drawings are merely a schematic diagram of preferred embodiments, and the module(s) or the flow(s) may not necessarily be required to implement the embodiments of the disclosure.

Those skilled in the art may appreciate that the modules in the devices of the embodiments may be distributed in the devices of the embodiments as described in the embodiments or located in one or more devices different from those of the embodiments given corresponding variations. The modules of the embodiments may be combined into one module or further subdivided into a plurality of sub-modules.

The embodiments of the disclosure have been numbered only for the sake of a convenient description but will not represent any superiority of one embodiment to another.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for controlling a boot screen to be played, comprising:
playing, by a user device, a boot screen upon being powered on;
detecting, by the user device, in real time whether a booting preparation of a booting signal source is completed; and
stopping, by the user device, the boot screen from being played upon detecting that the booting preparation of the booting signal source is completed.

2. The method according to claim 1, wherein detecting, by the user device, in real time whether the booting preparation of the booting signal source is completed comprises:
detecting, by the user device, in real time whether a preparation completion flag of an application corresponding to the booting signal source is read; and
determining, by the user device, that the booting preparation of the booting signal source is completed upon detecting that the preparation completion flag is read.

3. The method according to claim 2, wherein the user device sets the preparation completion flag of the application corresponding to the booting signal source by:
starting the application corresponding to the booting signal source to start the booting preparation after the user device is powered on; and
setting the preparation completion flag of the application corresponding to the booting signal source upon the booting preparation is completed.

4. The method according to claim 3, wherein the user device determines that the booting preparation is completed when one of the following situations occurs:
a booting preparation timer expires;
initialization of the application corresponding to the booting signal source is completed.

5. The method according to claim 2, wherein before the user device detects in real time whether the preparation completion flag of the application corresponding to the booting signal source is read, the method further comprises:
determining, by the user device, a signal source corresponding to a current signal identifier according to a preset correspondence relationship between a signal identifier and a signal source and taking the determined signal source as the booting signal source.

6. The method according to claim 5, wherein the method further comprises:
if the user device fails to determine the current signal identifier, then starting, by the user device, a first boot screen play timer; and
stopping, by the user device, the boot screen from being played after the first boot screen play timer expires.

7. The method according to claim 5, wherein the current signal identifier is set by the user device in one of the following schemes before the user device is powered off last time:
the user device determines a signal identifier corresponding to a default signal source as the current signal identifier;
the user device determines a signal identifier corresponding to a specific signal source preset by a user as the current signal identifier; and
the user device determines a signal identifier corresponding to a signal source used lastly before the user device is powered off last time as the current signal identifier.

8. The method according to claim 7, wherein setting, by the user device, the current signal identifier comprises:
setting, by the user device, the current signal identifier when a signal source is switched before being powered off last time.

9. The method according to claim 2, wherein the method further comprises:
starting, by the user device, a second boot screen play timer at the same time when detecting in real time whether booting preparation of the booting signal source is completed;
stopping, by the user device, the second boot screen play timer upon detecting that booting preparation of the booting signal source is completed before the second boot screen play timer expires; and
stopping, by the user device, the boot screen from being played after the second boot screen play timer expires.

10. A user device, comprising:
one or more processors; and
one or more computer readable memories;
wherein the one or more computer readable memories have instruction codes stored therein and the one or more processors execute the instruction codes so that the user device performs at least the following operations:
controlling the user device to play a boot screen upon being powered on;
detecting in real time whether a booting preparation of a booting signal source is completed; and
controlling the user device to stop the boot screen from being played upon detecting that the booting preparation of the booting signal source is completed.

11. The user device according to claim 10, wherein detecting in real time whether the booting preparation of the booting signal source is completed comprises:
detecting in real time whether a preparation completion flag of an application corresponding to the booting signal source is read; and
determining that the booting preparation of the booting signal source is completed upon detecting that the preparation completion flag is read.

12. The user device according to claim 11, wherein the user device sets the preparation completion flag of the application corresponding to the booting signal source by:
starting the application corresponding to the booting signal source to start the booting preparation after the user device is powered on; and
setting the preparation completion flag of the application corresponding to the booting signal source upon the booting preparation is completed.

13. The user device according to claim 12, wherein the user device determines that the booting preparation is completed when one of the following situations occurs:
a booting preparation timer expires;
initialization of the application corresponding to the booting signal source is completed.

14. The user device according to claim 11, wherein before the user device detects in real time whether the preparation completion flag of the application corresponding to the booting signal source is read, the operations further comprise:
determining a signal source corresponding to a current signal identifier according to a preset correspondence relationship between a signal identifier and a signal source and taking the determined signal source as the booting signal source.

15. The user device according to claim 14, wherein the operations further comprise: if the user device fails to determine the current signal identifier, then starting a first boot screen play timer; and controlling the user device to stop the boot screen from being played after the first boot screen play timer expires.

16. The user device according to claim 14, wherein the current signal identifier is set in one of the following schemes before the user device is powered off last time:
a signal identifier corresponding to a default signal source is determined as the current signal identifier;
a signal identifier corresponding to a specific signal source preset by a user is determined as the current signal identifier; and
a signal identifier corresponding to a signal source used lastly before the user device is powered off last time is determined as the current signal identifier.

17. The user device according to claim 16, wherein setting, by the user device, the current signal identifier comprises:
setting the current signal identifier when a signal source is switched before being powered off last time.

18. The user device according to claim 11, wherein the operations further comprise: starting, by the user device, a second boot screen play timer at the same time when detecting whether booting preparation of the booting signal source is completed; stopping the second boot screen play timer upon detecting that booting preparation of the booting signal source is completed before the second boot screen play timer expires; and stopping the boot screen from being played after the second boot screen play timer expires.

19. A computer readable storage medium, including instruction codes stored thereon, the instruction codes are executed to enable a user device to perform at least the following operations:
controlling the user device to play a boot screen upon being powered on;
detecting in real time whether a booting preparation of a booting signal source is completed; and
controlling the user device to stop the boot screen from being played upon detecting that the booting preparation of the booting signal source is completed.

20. The computer readable storage medium according to claim 19, where detecting, by the user device, in real time whether the booting preparation of the booting signal source is completed comprises:
detecting in real time, by the user device, whether a preparation completion flag of an application corresponding to the booting signal source is read; and
determining that the booting preparation of the booting signal source is completed upon detecting that the read preparation completion flag is read.
